(19) United States
(12) Patent Application Publication
(10) Pub. No.: US 2011/0283211 A1
(43) Pub. Date: Nov. 17, 2011

(54) METHODS FOR DESIGNING IMAGE-BASED PRODUCTS THROUGH A COMPUTER NETWORK

(76) Inventors: Susannah Ellen Butler, Menlo Park, CA (US); Chase Daniel Garber, Oakland, CA (US)

(21) Appl. No.: 12/777,932

(22) Filed: May 11, 2010

(51) Int. Cl. G06F 3/048

(52) U.S. Cl. 715/769; 715/853; 715/771

(57) ABSTRACT

A method for assisting a user to design an image-based product includes storing a component dependency map on a computer device that defines relationships among a first component, a second component, and a third component, which each comprises functions that define actions and states at a user interface on the computer device. The method also includes executing a page controller in association with the user interface on the computer device, detecting an activation of the functions of the first component at the user interface by the first component, and executing functions of the second component and the third component in the user interface in accordance to the component dependency map to obtain a design of the image-based product to be produced by the image-service provider.

### BACKGROUND OF THE INVENTION

In recent years, photography has been rapidly transformed from chemical based technologies to digital imaging technologies. Images captured by digital cameras can be stored in computers and viewed on display devices. Users can also produce image prints based on the digital images. Such image prints can be generated locally using output devices such an inkjet printer or a dye sublimation printer or remotely by a photo printing service provider. Other products that can be produced using the digital images can include photo books, photo calendars, photo mug, photo T-shirt, and so on. A photo book can include a cover page and a plurality of image pages each containing one or more images. Designing a photobook can include many iterative steps such as selecting suitable images, selecting layout, selecting images for each page, selecting backgrounds, picture frames, overall Style, add text, choose text font, and rearrange the pages, images and text, which can be quite time consuming. Designing a photobook may thus require many communications between a user's computer and the central server hosted by the image service provider. Small delays in the responses to user's commands can add significant time in the whole book creation project, which affects user experience.

It is desirable to have systems and methods that can enable users to design image-based products in a time efficient manner.

### SUMMARY OF THE INVENTION

Embodiments may include one or more of the following advantages. The disclosed systems and methods provide more effective ways for users to design image-based products over a computer network. The user interface for creating an image-based product is easier to use and can provide faster response to users' commands. As a result, the time needed to create an image-based product is reduced, and user's experience can be enhanced. Effective organization and management of components that enable the user interface also allow more effective development process and faster turn-around for upgrading the user interfaces.

The disclosed methods and systems can also have fewer bugs in the computer code that enable users to design image-based products because the logic relationship between and the sequence of the actions at the user interface are clearly defined. The disclosed methods also allow developers to have a clear view of a page of an image-based product by looking at a dependency map of the components in the page. Furthermore, components in the computer code are reusable across different pages because the logic of how the components interact in a given page is stored in a page controller instead of in the components.

In one aspect, the present application relates to a method for assisting a user to design an image-based product. The method includes storing, on a computer device, a component dependency map that defines relationships among a first component, a second component, and a third component, each of which comprises functions that define actions and states at a user interface on the computer device; executing a page controller in association with the user interface on the computer device, wherein the page controller can control the first component, the second component, and the third component in accordance to the component dependency map; detecting an activation of the functions in the first component at the user interface; and executing functions of the second component and the third component in the user interface in accordance with the component dependency map to obtain a design of the image-based product to be produced by the image-service provider.

Implementations of the methods may include one or more of the following. The activation can be detected by the first component and communicated to the page controller, wherein functions of the second component and the third component can be respectively executed by the second component and the third component in communication with the page controller. The component dependency map can define that the functions in the second component and the third component are to be executed after the functions in the first component. The functions in the third component can be executed after the functions in the second component in accordance with the component dependency map. The component dependency map can further define a fourth component having functions to be executed after the execution of the functions in the second component and the third component. The method can further include retrieving data from a second component model in the second component or a third component model in the third component, wherein functions of the second component or the third component are executed using the data retrieved from the second component model or the third component model. The first component model, the second component model, and the third component model can store an image or text, names of the objects, or positions, colors, dimensions, resolutions, or aspect ratios of the one or more objects, which are associated with the first component. The method can further include retrieving data from a page model associated with the page controller, wherein functions of the first component, the second component and the third component can be executed using the data retrieved from the page model. The computer device can be in communication with a server hosted by an image-service provider. The method can further include sending a bundled request by the page controller to the server to request data related to the second component and the third component in accordance to the component dependency map; receiving data related to at least two of the first component, the second component, and the third component from the server by the page controller, wherein functions of at least two of the first component, the second component, and the third component are executed using the data received from the server. The server can store a product creation controller that can send the data related to the first component, the second component, and the third component to the page controller in response to the bundled request by the page controller; and a product model accessible to the product creation controller and configured to store specifications of the image-based product. The product model can store objects comprising an image or text, names of the objects, or positions, colors, dimensions, resolutions, or aspect ratios of the one or more objects, which define the image-based product. The image-based product can include a photo page, a photo collage, a photo book having a plurality of pages, a personalized greeting card, a photo stationery, a image print, a photo calendar, a photo banner, a photo card, a photo T-shirt, a photo coffee mug, a photo mouse pad, a photo key-chain, a photo collector, or a photo coaster. The image-based product can include a page, wherein the page controller is configured to control the logic and invocations of the first component, the second component, and the third component to enable the design of the page. The functions of the first component can be activated by a user. The functions in the first component can define a user initiated movement of an image from a first location to a second location on the user interface. The first component, the second component, and the third component can respectively include a first component controller, a second component controller, and a third component controller, wherein the first component controller, the second component controller, and the third component controller are respectively configured to control the executions of the functions in the first component, the second component, and the third component under the control of the page controller.

In another aspect, the present application relates to a method for assisting a user to design an image-based product. The method includes storing, on a computer device, a component dependency map that defines that the functions in a second component and a third component are to be executed after the functions in a first component, each of which comprises functions that define actions and states at the user interface on the computer device; executing a page controller in association with the user interface on the computer device, wherein the page controller can control the first component, the second component, and the third component in accordance to the component dependency map; detecting an activation of the functions in the first component at the user interface by the first component; executing functions of the second component and the third component in the user interface in accordance to the component dependency map; sending a bundled request, by the page controller, to a product creation controller on the server to request data related to at least two of the first component, the second component, and the third component; retrieving the data from a product model accessible to the product creation controller, wherein the product model can store specifications of the image-based product, wherein the specifications can include an image or text, names of the objects, or positions, colors, dimensions, resolutions, or aspect ratios of the one or more objects, which define the image-based product; and receiving the data from product creation controller by the page controller, wherein the functions of the first component, the second component, and the third component can be executed using the data received from the server to result in a design of the image-based product to be produced by the image-service provider.

In another aspect, the present application relates to a method for assisting a user to design an image-based product. The method includes storing a first component and a second component on a computer device, each of the first component and the second component comprises functions that define actions and states at a user interface on the computer device; storing, on a computer device, a component dependency map that defines that the functions in the second component are to be executed after the functions in a first component; executing a page controller in association with the user interface on the computer device, wherein the page controller can control the first component and the second component in accordance to the component dependency map; detecting an activation of the functions in the first component at the user interface; and invoking functions of the second component in the user interface in accordance with the component dependency map to obtain a design of the image-based product to be produced by the image-service provider. The method can further include storing a third component on the computer device and invoking functions of the third component in the user interface in accordance with the component dependency map, wherein component dependency map that defines that the functions in the third component are to be executed after the functions in a first component and the second component.

### BRIEF DESCRIPTION OF THE DRAWINGS

The accompanying drawing, which are incorporated in and form a part of this specification, illustrate embodiments of the invention and, together with the description, serve to explain the principles of the invention:

FIG. 1 is a block diagram of a system for producing personalized image-based products.

FIG. 2 illustrates an exemplified computer compatible with the system of FIG. 1.

FIG. 3 illustrates an exemplified architecture for creating personalized image-based products compatible with the system of FIG. 1.

FIG. 4 illustrates an example of a component dependency map in FIG. 3.

FIGS. 5A-5D illustrate a family of related components in the creation of a personalized image-based product.

FIG. 6 illustrates the design of a personalized image-based product.

FIG. 7 shows an exemplified process for assisting a user to design a personalized image-based product at a user interface.

Although the invention has been particularly shown and described with reference to multiple embodiments, it will be understood by persons skilled in the relevant art that various changes in form and details can be made therein without departing from the spirit and scope of the invention.

### DETAILED DESCRIPTION OF THE INVENTION

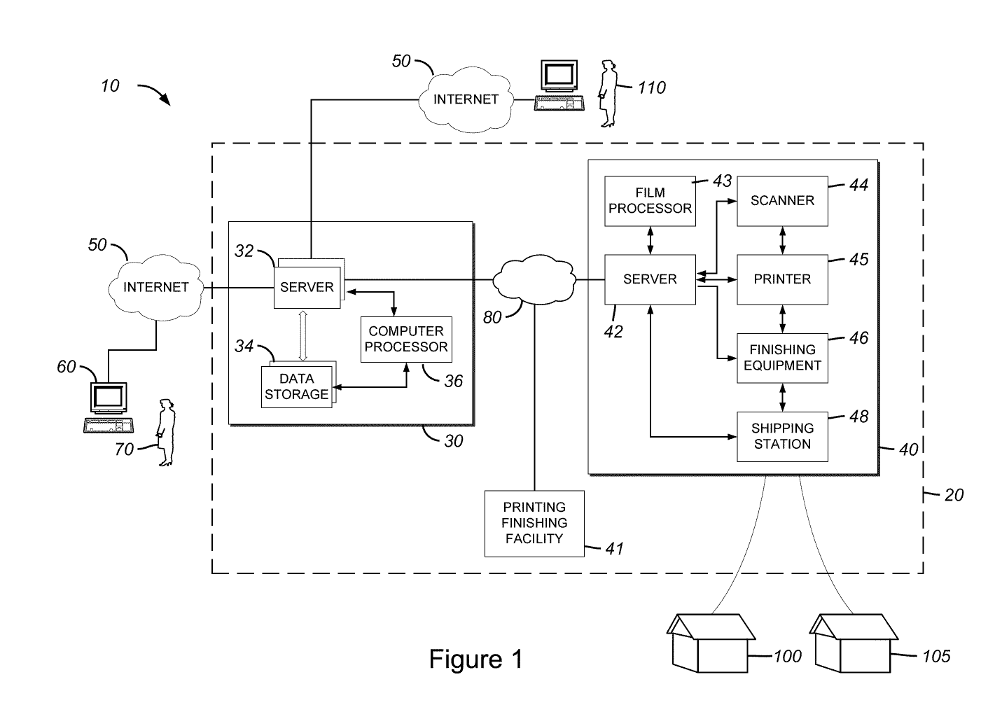

FIG. 1 shows a block diagram of a system 10 for producing personalized image-based products. An online photo system 20 can be established by an image service provider to provide image services and products on a wide area network such as the Internet 50. The online photo system 20 can include a data center 30, one or more product fulfillment systems 40 and 41, and a computer network 80 that can facilitate the communications between the data center 30 and the product fulfillment systems 40 and 41.

In the present specification, the term “personalized” is used in personalized content, personalized messages, personalized images, and personalized designs that can be incorporated in the personalized products. The term “personalized” refers to the information that is specific to the recipient, the user, the gift product, or the intended occasion. The content of personalization can be provided by a user or selected by the user from a library of content provided by the image-server provided. The content provided can include stock images and content licensed from a third party. The term “personalized information” can also be referred to as “individualized information” or “customized information”. Examples of personalized image-based products may include personalized photo greeting cards, photo prints, photo books, photo T-shirt, and photo, mugs etc. The personalized image-based products can include users' photos, personalized text, and personalized designs.

In the present application, image-based products can include photo books, personalized greeting cards, photo stationery, photo or image prints, photo posters, photo banners, photo playing cards, photo T-shirts, photo coffee mugs, photo mouse pads, photo key-chains, photo collectors, photo coasters, or other types of photo gift or novelty item. The term “photo book” refers to books that include one or more pages and at least one image on a book page. Photo books can include photo albums, scrapbooks, bound photo calendars, or photo snap books, etc. The photo book in the disclosed system can include personalized image and text content provided by a user or by a third party.

The data center 30 can include one or more servers 32, data storage devices 34 for storing image data, user account and order information, and one or more computer processors 36 for processing orders and rendering digital images. An online-photo website can be powered by the servers 32 to serve as a web interface between the users 70 and the image service provider. The users 70 can order image-based products from the web interface. The product fulfillment systems 40 and 41 can produce the ordered image-based products such as photographic prints, greeting cards, holiday cards, post cards, photo albums, photo calendars, photo books, photo T-shirt, photo mugs, photo aprons, image recording on compact disks (CDs) or DVDs, and framed photo prints. The architecture of the data storage devices 34 is designed to optimize the data accessibility, the storage reliability and the cost.

The image product fulfillment system 40, 41 can be co-located at the data center 30. Alternatively, the image product fulfillment system 40, 41 can be located remotely from the data center 30. The image product fulfillment system 40, 41 can be set up. Each image product fulfillment system 40 or 41 can be geographically located close to a large population of customers to shorten order delivery time. Furthermore, the product fulfillment systems 40 and 41 and the data center 30 can be operated by different business entities. For example, a first business entity can own the data center 30 and host the website that can be accessed by the users 70. The product fulfillment systems 40 and 41 can be owned and operated by a second business entity (i.e. an application service provider).

The image product fulfillment system 40 can include one or more servers 42, printers 45 for printing images on physical surfaces, finishing equipment 46 for operations after the images are printed, and shipping stations 48 for confirming the completion of the orders and shipping the ordered image-based products to the user 70 or recipients 100 and 105. The servers 42 can communicate with the data center 30 via the computer network 80 and facilitate the communications between different devices and stations in the image product fulfillment system 40. The computer network 80 can include a Local Area Network, a Wide Area Network, and wireless communication network.

The printers 45 can receive digital image data and control data, and reproduce images on receivers. The receivers can be separate photo prints, or pages to be incorporated into photo books. Examples of the printers 45 include can be digital photographic printers, offset digital printers, or digital printing presses. The printers 45 can also include inkjet. The product fulfillment systems 40 and 41 can include a film processor 43 for processing exposed films, and a scanner 44 for digitizing processed film stripes. The order information and image data can be transferred from servers 32 to the servers 42 using a standard or a proprietary protocol (FTP, HTTP, among others).

The finishing equipment 46 can perform operations for finishing a complete image-based product other than printing, for example, cutting, folding, adding a cover to photo book, punching, stapling, gluing, binding, envelope printing and sealing, packaging, labeling, package weighing, and postage metering. The finishing operations can also include framing a photo print, recording image data on a CD-ROM and DVD, making photo T-shirts and photo mugs, etc. Furthermore, the printers 45 and the finishing equipments 46 can reside at different locations.

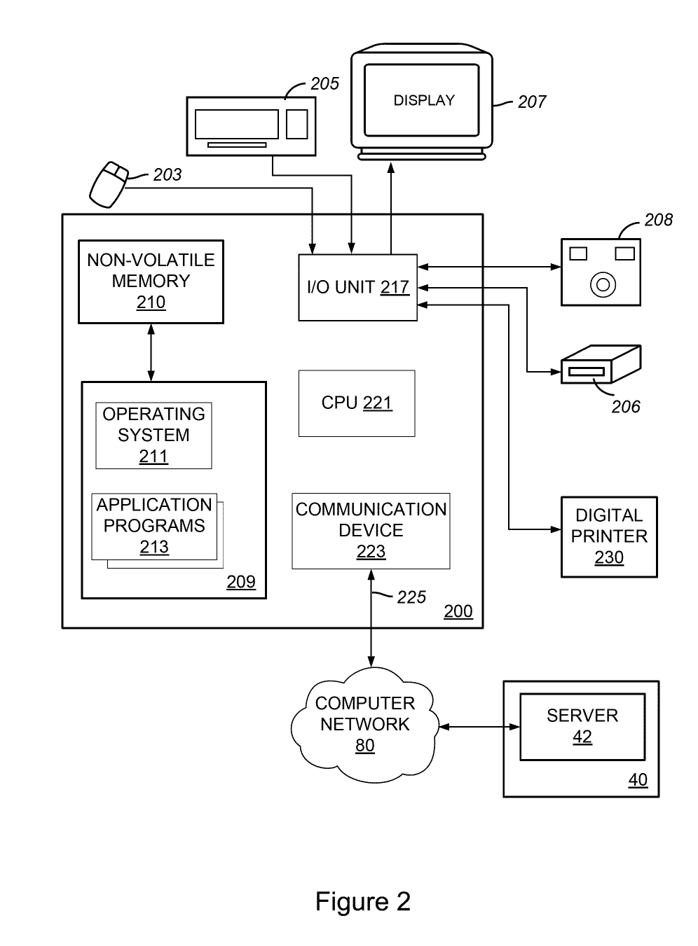

A user 70 can access the online-photo website using a computer device 60 as shown in FIG. 2. The computer device 60 can be a personal computer, a portable computer device, or a public computer terminal such as a kiosk. The computer device 60 allows a user 70 to execute software to perform tasks such as communicating with other computer users, accessing various computer resources, and viewing, creating, or otherwise manipulating electronic content, that is, any combination of text, images, movies, music or other sounds, animations, 3D virtual worlds, and links to other objects. Exemplary components of the computer device 60, shown in FIG. 2, include input/output (I/O) devices (mouse 203, keyboard 205, display 207) and a general purpose computer 200 having a central processor unit 221, an I/O unit 217 and a memory 209 that stores data and an operating system 211, and one or more application programs 213 including applications for viewing, managing, and editing digital images. The computer 200 also includes non-volatile memory 210 and a communications device 223 for exchanging data with an Internet 50 via a communications link 225 (e.g. an optical fiber, cable, telephone line, and wireless communication etc.). The user can use a web browser to communicate with image product fulfillment system 40.

The computer 200 can communicate with various peripheral I/O devices such as an image capture device (digital camera, film scanner or reflective scanners) in wired or wireless communication methods to allow the images to be transferred to a non-volatile memory 210 using a card reader 206.

The computer 200 allows the user 70 to communicate with the online-photo website using the communication device 223. The user 70 can set up and access her personal account. The user 70 can enter user account information such as the user's name, address, payment information, and information about the recipient of the image-based products. The user 70 can upload digital images to the online-photo website. The user can store images in an online photo album, create personalized image-based product at the web user interface, and order a personal image-based product and a gift product for specified recipients 100 and 105. The user 70 can design and order physical image-based products via the Internet using service provided by an online image service provider such as Shutterfly, Inc., located at Redwood City, Calif. The production of these image-based products often requires the use of commercial equipment available at the image product fulfillment system 40 and 41.

After the image service provider has received the user's images, the image service provider can host the images on the online photo website, at which the user can view and access the images using a web browser or a locally installed software application. The user 70 can access the online-photo website to create and design a photo-based product such as a photo book and a photo greeting card, and specify the images to be reproduced on an image-based product and parameters relating to printing (e.g., finish, size, the number of copies). The user 70 can also designate one or more recipients 100 and 105 to whom the image-based products are to be sent. The user can place an order of the image-based product with the image service provider. The information entered by the user 70 can be stored on the server 32 and the data storage 34, and subsequently transmitted to an image product fulfillment system 40 or 41. The image-based products are printed by the printer 45 and finished by finishing equipment 46 according to the printing parameters as specified by the user 70. The image-based products are then delivered to the specified recipients 100.

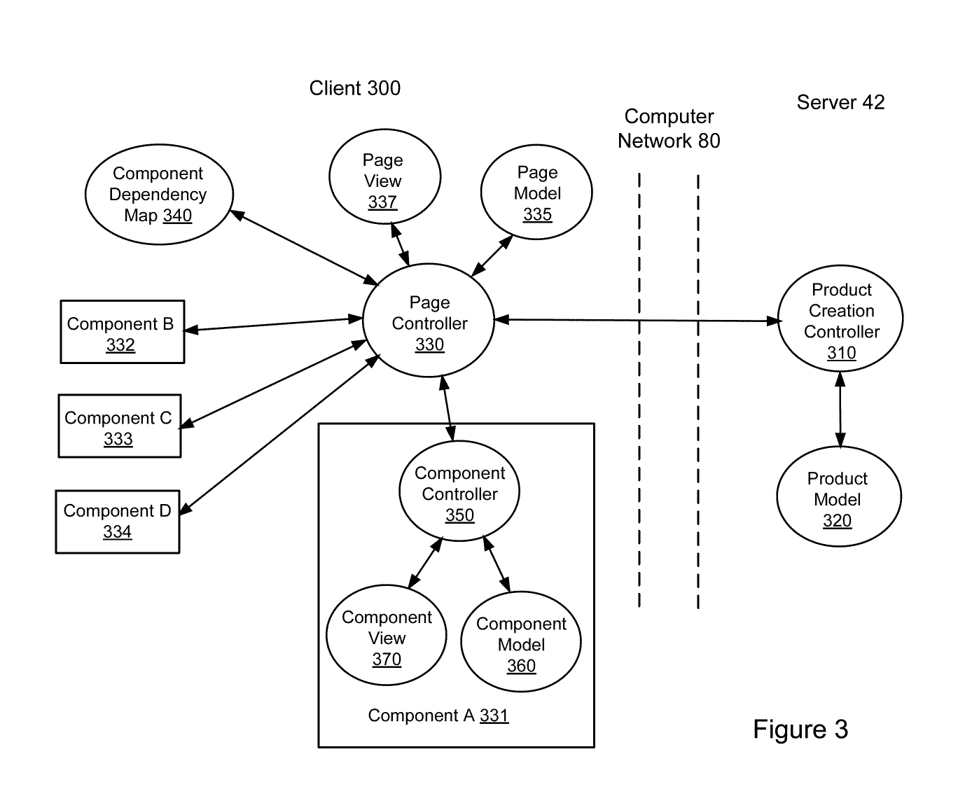

The system 10 (FIG. 1) is compatible with architecture for creating personalized image-based products, as shown in FIG. 3. The architecture includes a client 300 that is in communication with the server 42 via the computer network 80. The server 42 can support an application called product creation controller 310 and store a product model 320.

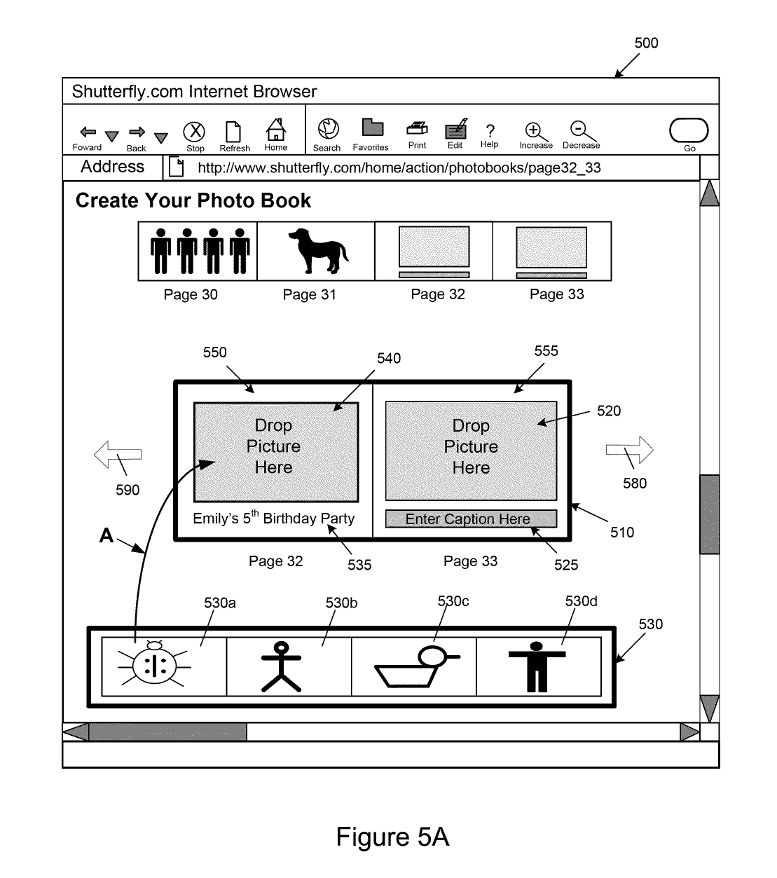

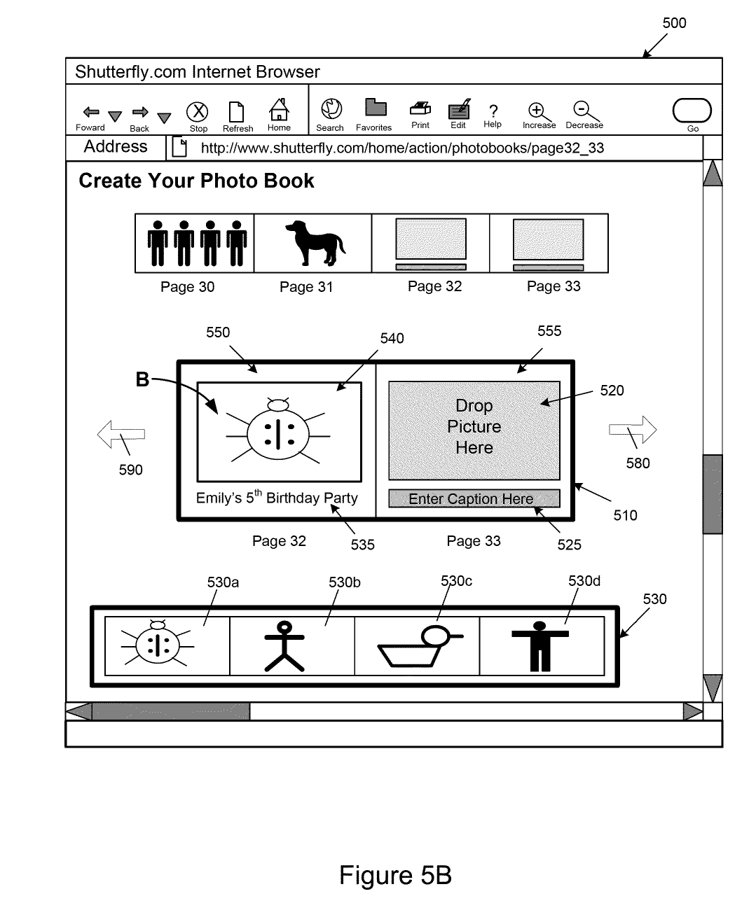

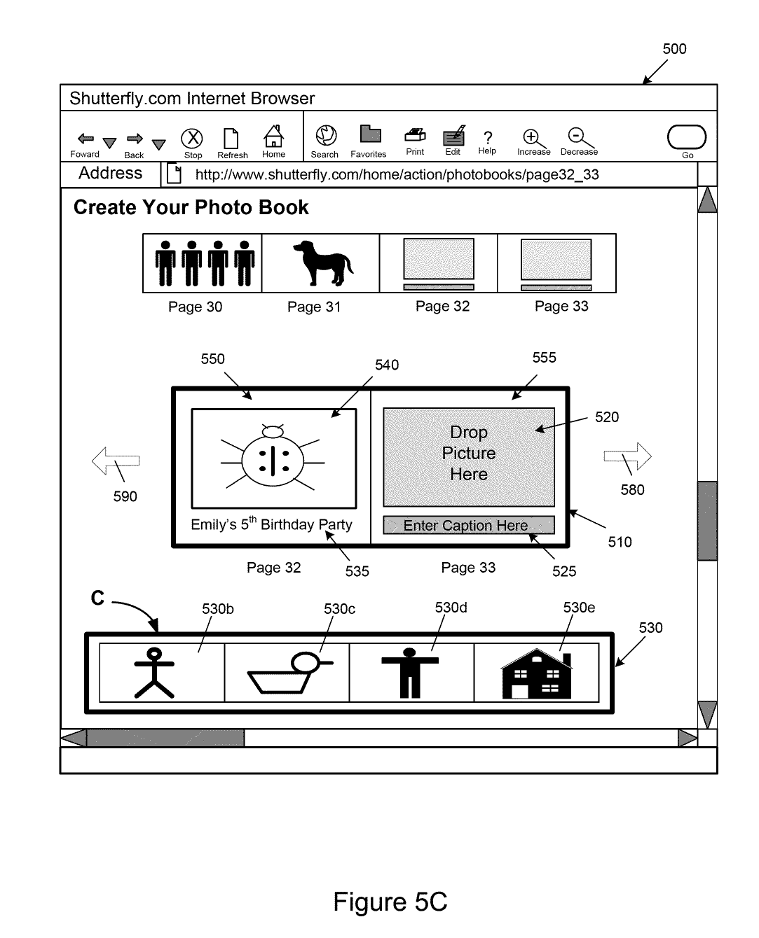

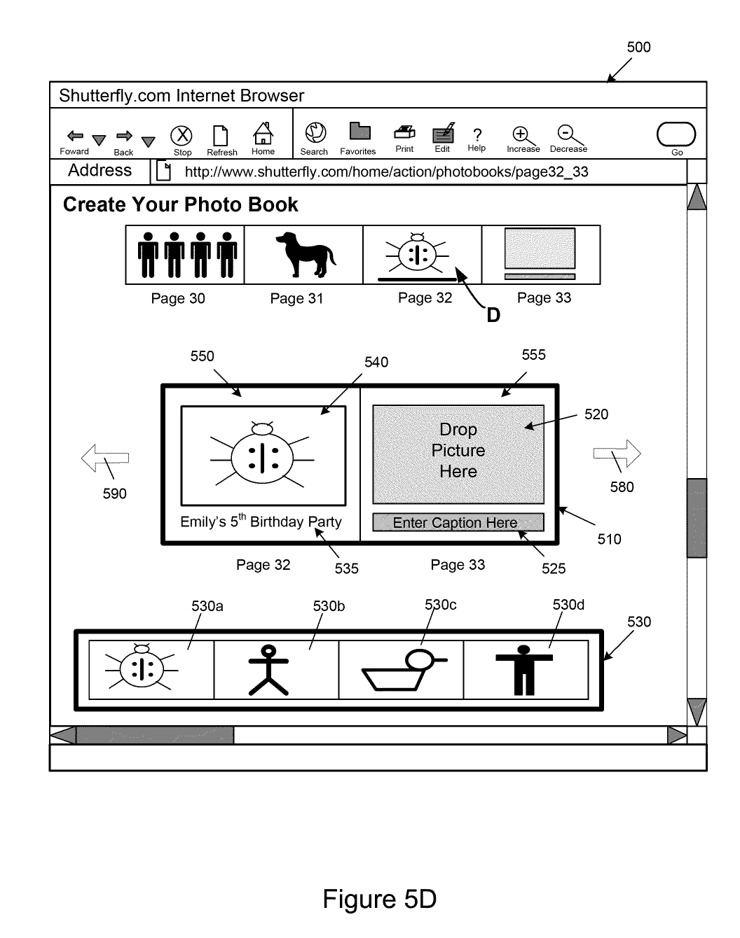

The client 300 includes a page controller 330, a component dependency map 340 accessible by the page controller 330, and a plurality of components A, B, C, D (331-334), etc. Each component, as shown in the example of component A, can include a component controller 350, a component model 360 and a component view 370. A component is an encapsulation of functionality, which may consist of action and state. In practice, a component is computer code with functions that express behavior and variables that store state. In component A, for example, the component model 360 stores and manipulates data used by the component. The component view 370 manages the visual representation of the component on the computer screen. The component view 370 can detect and accept input from the user. In other words, the component view 370 serves as component A's interface interacting with the user interface (500 in FIGS. 5A-5D).

The component controller 350 does not communicate with or have knowledge about the component dependency map 340. Each component controller 350 communicates with the page controller 330 on behalf of the entire component. The component controller 350 manages the component model 360 and the component view 370. The component controller 350 carries out business logic that determines how the overall component functions.

The page controller 330 defines the jobs (i.e. components to be executed) for the components whereas the component controllers 350 execute the jobs with the assistance of their component models 360 and the component views 370. The component model 360 stores an associated component's properties, which in part governs the actions of its associated component view 370. When the component model 360 updates, then its associated component view 370 also updates. The component view 370 is also governed by user interactions. For example, when a user clicks on a link; the corresponding component view responds.

The component views in different components define different portions of a page view. A page view can include the layout of one photobook page or two opposing photobook pages in a single view. Each view, as shown by the pages 550, 555 in FIGS. 5A-5D, can include multiple image and text objects, provided by a user or an image service provider. The positions, dimensions, borders, cropping properties, color tones, colors of the text fonts, the background style or theme, etc., and the changes in these properties, are stored, and updated in the product model 320 and the component models 360.

On the server side, the product model 320 stores necessary data for the design and specification of an image-based product. For a photobook, for example, the product model 320 can store the number of pages, image and text content on the pages, the background design or styles or theme of the photobook, the type of book finish, the colors of the book covers, etc. The information and the data structure for each page view in the component models 360 are in frequent communication with the corresponding information and data structure in the product model 320 such that their data values are synchronized.

In some embodiments, still referring to FIG. 3, the page controller 330 can be associated with a page model 335 and a page view 337 in the client 300. The page model 335 and the page view 337 are governed by the page controller 330, and encompass functionality that is not handled by the components.

The component model 360 may contain a subset of the data in the product model 320, for example, data for an image or text, and positions, colors, dimensions, resolutions, and aspect ratios of the objects associated with the execution of the component. The page controller 330 is responsible for communicating with the product creation controller 310 on the server side. It can provide data needed for the page controller 330 and the component controller 350 to execute component functions, as described below, as well as updating the logic dependencies between components in the component dependency map 340 and data structures in the component model 360.

The page controller 330 handles updating the component models 350 in different components 331-334, If a change to the component model 360 is a result of a page-level action (e.g. actions taken by the page controller 330 or action by another component that has notified the page controller 330), the page controller 330 informs the affected component controller about the change, and provides it data about what changed. The component controller can then update its associated component model.

The component model 360 updates its information without the knowledge about the cause of the changes. In some embodiments, the data is changed on the client 300 without the need to interact with the server 42. In some case, the data are changed at the page level. For example, the changes can be entirely about the application user interface. One or more components within the page may be impacted. There is no need for communication with the server 42 and the product model 320. The page controller 330 forwards the new data to the component controller 350, which updates its component model 360. If the data change happens internally within the component (e.g. as a result of a user action), the component controller 350 can inform its component model 360 to update directly without going through the page controller 330.

For example, the component controller 350 can control the execution of components A, B, C, D, E, F, G, etc. The logical relationships between the actions and particular functions of the components A-G are defined in the component dependency map 340. Each of the components A-G is associated with a component controller that can be coupled with a component model and a component view.

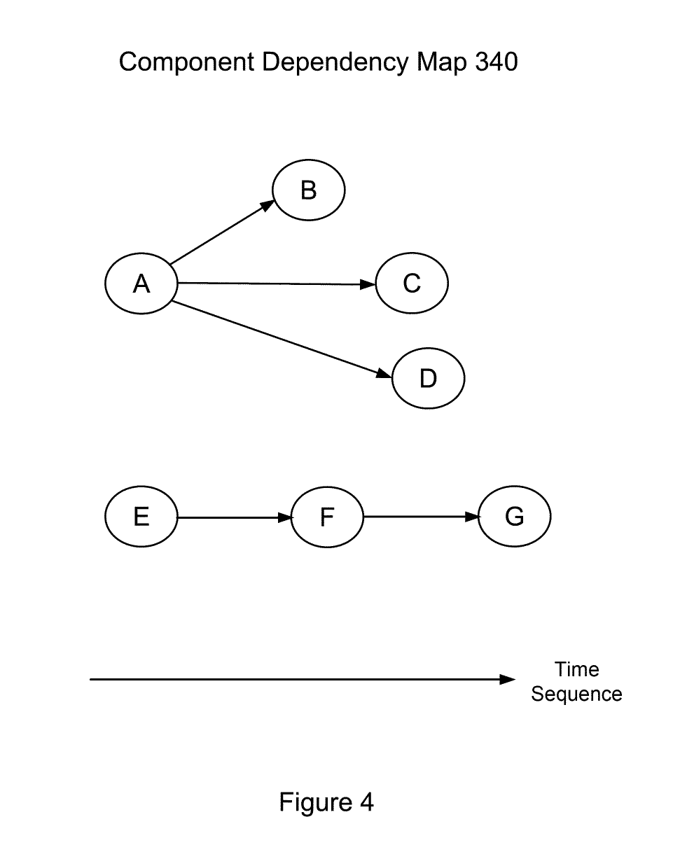

An example of the component dependency map 340 is shown in FIG. 4. The execution of component A triggers the executions of functions on components B, C, and D. In addition, functions of the components A, B, C and D should be executed in temporal sequence as determined by the requirements of the application. Similarly, components E, F, and G relate to each other in a linear sequential fashion as defined in the dependency map 340.

The implementations of the components A, B, C, and D are illustrated in FIGS. 5A-5D. Referring to FIG. 5A, a user interface 500 provides a template for a user to design an image based product such as a photobook 510. A photo book 510 can include layouts for pages 550 and 555 (Page 32 and Page 33), which can include image receiving areas 520 and 540 and text receiving areas 525 and 535. The text receiving area 535 can for example include text caption “Emily's 5^{th} Birthday”. The pages 550 and 555 can also display a background design in certain style of theme.

An image collection 530 displayed below the layout for the pages 550 and 555 include a plurality of images 530a-530d that are available to be used in the photo book 510. A plurality of thumbnail images of the pages in the photobook 510 can be displayed above the pages 550 and 555. The thumbnail images are miniature image presentations of “Page 30”, “Page 31”, “Page 32”, and “Page 33”. A user can click on each of the thumbnail images to navigate a particular page. A user can also navigate to different pages of the photo book 510 by clicking the buttons 580 and 590 respectively.

To incorporate an image 530a into the page 550, a user can drag and drop the image symbol 530a to the image receiving area 540. The dragging and the dropping of an image from the image collection 530 are defined as functions in a component A in the client. Once the component view 370 (FIG. 3) detects a user's drag and drop command at the user interface 500, referring to FIG. 3, the component controller 350 reports it to the page controller 330. The page controller 330 extracts from the component dependency map 340 information about the component A, and components B, C, D that have logical relationships with component A (FIG. 3). For component A, for example, the page controller needs to fetch an image to appear in the image receiving area 540. Moreover, the component dependency map 340 specifies that function calls on the components A, B, C, D should occur sequentially.

In accordance to the component dependency map 340, referring to FIG. 3, the components B, C, D are then invoked by their respective component controllers 350 (FIG. 3) in response to the invocation of the component A. because the page controller is actually making the requests, but does not contain the knowledge of what requests to make. The page controller 330 creates a bundled request on behalf of the components A, B, C, D and sends the bundled request to the product creation controller 310 on the server 42 to gather all the data needed for the execution of functions on components A, B, C, D. The data, as described below, can include a large version of the image 530a to be displayed in the image receiving area 540. A thumbnail-size rendered image of Page 32 to be displayed above the pages 550 and 555. The image sizes are specified by data stored in the component model 360. The bundled request can also demand state changes in the product model 320. The product creation controller 310 retrieves necessary data from the product model 320 and replies to the page controller 330 in a bundled request to provide all data needed for executing components B, C, and D. The page controller 330 subsequently sends commands to the component controllers 350 to sequentially invoke functions on components B, C, D in response to component A.

Referring to FIG. 5B, the execution of a function on component B by the component controller 350 at the component view 370 (FIG. 3) causes a large version of the thumbnail sized image 530a to be displayed in the image receiving area 540 in place of the blank box (with message like “Drop Picture Here”), which indicates the reception of the image 530 by the image receiving area 540.

Subsequent to the execution of the function on component B, referring to FIG. 5C, the component C is executed at the component view 370 (FIG. 3). The image 530a is removed from the image collection, and the images 530b-530e are moved to the left to indicate that the image 530b has been used by one of the pages in the photobook 510, and is no longer available.

Subsequent to the execution of the function on component C, referring to FIG. 5D, the component D is executed at the component view 370 (FIG. 3). The thumbnail image for Page 32 is updated to include the new image content in the image receiving area 340.

After the execution of the functions on components A, B, C, D, the page controller 330 can send a message to the product creation controller 310 about the completion of functions on the components A, B, C, D, wherein the states of the photo book is updated in the product model 320.

An advantage of the above described methods is that the communication traffic between the client and the server is greatly reduced comparing to some conventional systems. The knowledge stored in the component dependency map 340 allows the page controller 330 to plan a family of actions (which can be for different components) together and receive the necessary data for the group of actions in a single bundled request.

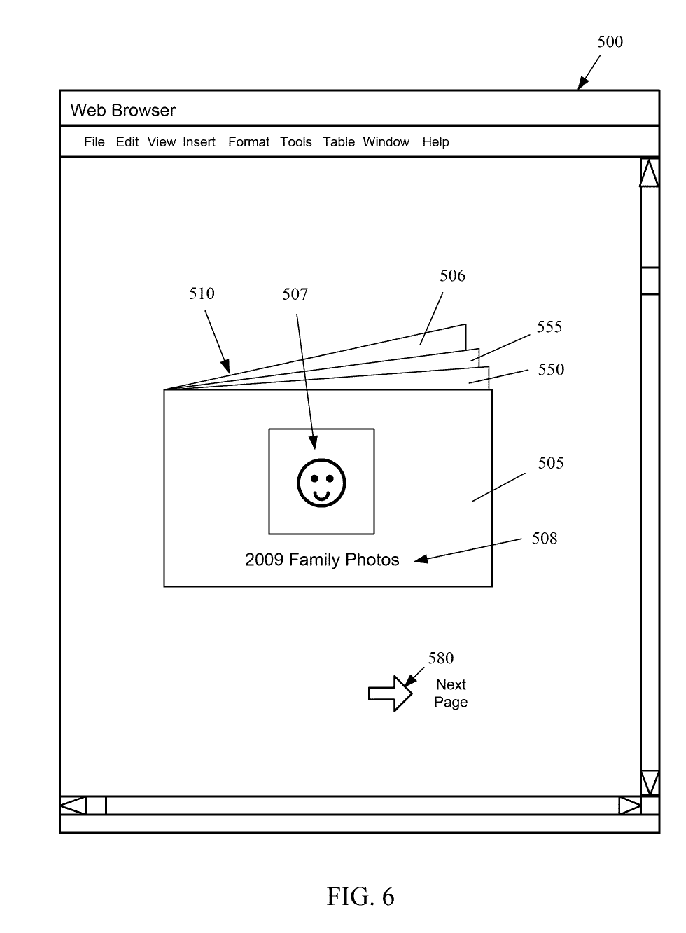

After the design of a photo book 510 is completed, a user can browse in the design at the user interface 500, as shown in FIG. 6. The photobook 510 can include a front cover 505, a back cover 506, and a plurality of pages 550, 555. The front cover can include an image 507 and text 508. A user can browse and proof different pages of the photobook by clicking button 580.

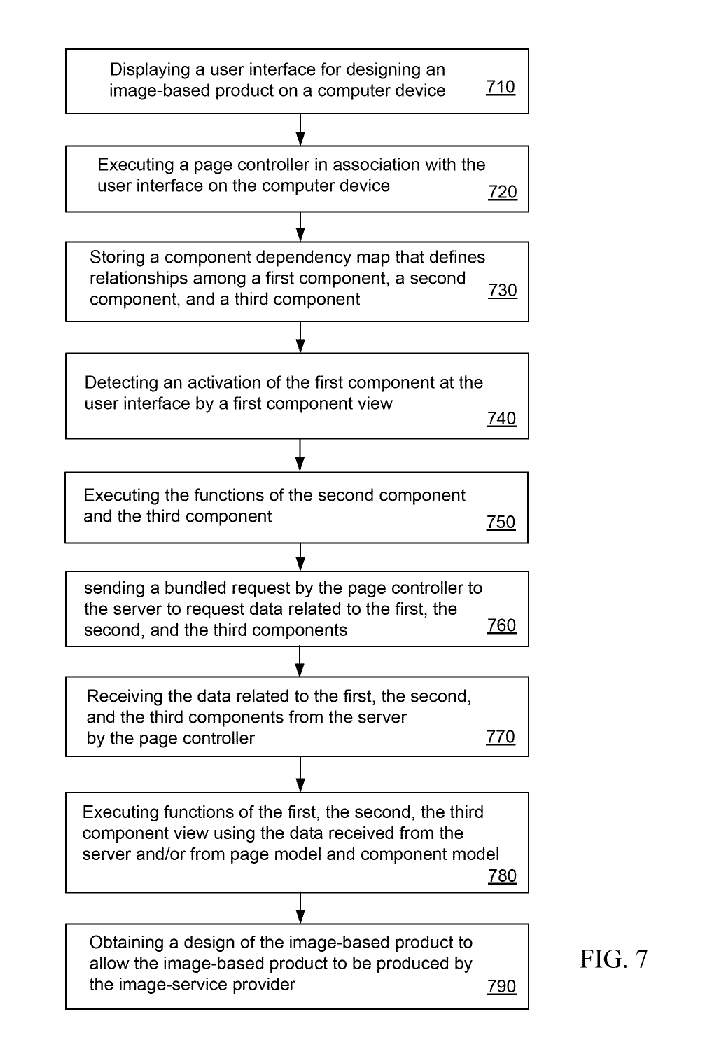

An exemplified process for assisting a user to design an image-based product, as shown in FIG. 7, can include one or more of the following steps: a user interface for designing an image-based product is displayed on a computer device (step 710). The computer device is in communication with a server hosted by an image-service provider. A page controller application is executed on a computer device in association with a user interface (step 720). A component dependency map is stored on the computer device (step 730). The component dependency map is accessible by the page controller, and defines relationships among a first component, a second component, and a third component. Each of the first component, the second component, and the third component comprises functions that define action and state at the user interface. A user initiated activation of the first component at the user interface is detected by a first component view associated with the first component (step 740). In accordance to the component dependency map, the functions of the second and the third components (and other component as defined in the component dependency map) are invoked (step 750).

The page controller then sends a bundled request, on behalf of the first and the second components, to the server to request data related to the first, the second, and the third components (step 760). The data related to the first, the second, and the third components are received from the server by the page controller (step 770). Functions of the first, the second, and the third component are executed in the user interface using the data received from the server (step 780). A design of the image-based product is obtained, which allows the image-based product to be produced by the image-service provider (step 790).

In some embodiments, the invocation of the first component does not require data from the server; the steps 760 and 770 can be skipped. In the step 780, the functions of the components can be executed under the direction of the page controller according to the component dependency map using data from the page model 335 or component models (360). In some embodiments, the invocation of the first component does not require data from the server for all the components. For example, only component A may require data from the server, while components B and C can retrieve data from the page model 335 or component models (360). The request by the page controller can thus be only for data for the first component.

Embodiments may include one or more of the following advantages. The disclosed systems and methods provide more effective ways for users to design image-based products over a computer network. The user interface for creating an image-based product is easier to use and can provide faster response to users' commands. Effective organization and management of components that enable the user interface also allow a more effective development process and faster turn-around for upgrading the user interfaces.

The disclosed methods and systems can also have fewer bugs in the computer code that enable users to design image-based products because the logic relationship between and the sequence of the actions at the user interface are clearly defined. The disclosed methods also allow developers to have a clear view of a page of an image-based product by looking at a dependency map of the components in the page. Furthermore, components in the computer code can be reusable across different pages because the components encapsulate logic of their functions and the dependency map stores logic about how components interact on a given page. In other words, the application logic is stored in the page controller; component logic is encapsulated within each component.

It should be noted that the disclosed methods and systems can be implemented without the specific arrangements or configurations (e.g. examples shown in FIGS. 3 and 4). For example, a component does not have to include the structure of a component controller, a component model, and a component view. The component exposes a public API (application programming interface) that the page controller can use to create entries in its dependency map. The page controller can then use those entries to invoke public methods on a component. The page controller only interacts with the component controller regardless of how the component is internally structured.

It is understood that the above disclosed system and methods can be implemented in various forms without deviating from the spirit of the specification. For instance, the disclosed system and methods are not limited to the layout of the photobook design. The images and text can be incorporated into an image based product in different ways from the method shown above. The presently disclosed systems and methods are compatible with software applications for communications between a client and server, other than a web browser.

Moreover, a page controller is not limited to use in creating a photobook page. Rather, a page controller is applicable to a single view of other image-based product such as a photo greeting card, a photo T-shirt, a page of a photo calendar, a photo mug, etc.

More than one user can be involved in the creation of a photo book incorporating personal photo content and sellable pages from a third party. The users can collaboratively create the photo book using a local computer system or a network-based system. Details about how users can collaboratively create photo books are disclosed in commonly assigned U.S. patent application Ser. No. 11/207,666, titled “System and methods for collaborative scrapbook creation”, filed on Aug. 19, 2005, the disclosure of which is incorporated herein by reference.

It should be noted that image-based products other than the examples used above may be compatible with the present disclosure. Other examples of image-based products include, but not limited to, a photo page, a photo collage, a photo book having a plurality of pages, a personalized greeting card, a photo stationery, a image print, a photo poster, a photo banner, a photo playing card, a photo T-shirt, a photo coffee mug, a photo mouse pad, a photo key-chain, a photo collector, or a photo coaster.

What is claimed is:

1. A method for assisting a user to design an image-based product, comprising:
storing, on a computer device, a component dependency map that defines relationships among a first component, a second component, and a third component, each of which comprises functions that define actions and states at a user interface on the computer device;
executing a page controller in association with the user interface on the computer device, wherein the page controller is configured to control the first component, the second component, and the third component in accordance to the component dependency map;
detecting an activation of the functions in the first component at the user interface; and
executing functions of the second component and the third component in the user interface in accordance with the component dependency map to obtain a design of the image-based product to be produced by the image-service provider.

2. The method of claim 1, wherein the activation is detected by the first component and is communicated to the page controller, wherein functions of the second component and the third component are respectively executed by the second component and the third component in communication with the page controller.

3. The method of claim 1, wherein the component dependency map defines that the functions in the second component and the third component are to be executed after the functions in the first component.

4. The method of claim 1, wherein the functions in the third component are executed after the functions in the second component in accordance with the component dependency map.

5. The method of claim 1, wherein the component dependency map further defines a fourth component having functions to be executed after the execution of the functions in the second component and the third component.

6. The method of claim 1, further comprising:
retrieving data from a second component model in the second component or a third component model in the third component, wherein functions of the second component or the third component are executed using the data retrieved from the second component model or the third component model.

7. The method of claim 6, wherein the second component model and the third component model store an image or text, names of the objects, or positions, colors, dimensions, resolutions, or aspect ratios of the one or more objects, which are associated with the first component.

8. The method of claim 1, further comprising:
retrieving data from a page model associated with the page controller, wherein functions of the second component and the third component are executed using the data retrieved from the page model.

9. The method of claim 1, wherein the computer device is in communication with a server hosted by an image-service provider, the method further comprising:
sending a bundled request by the page controller to the server to request data related to at least two of the first component, the second component, and the third component in accordance to the component dependency map; and
receiving data related to at least two of the first component, the second component, and the third component from the server by the page controller, wherein functions of the second component and the third component are executed using the data received from the server.

10. The method of claim 9, wherein the server is configured to store:
a product creation controller configured to send the data related to the first component, the second component, and the third component to the page controller in response to the bundled request by the page controller; and
a product model accessible to the product creation controller and configured to store specifications of the image-based product.

11. The method of claim 10, wherein the product model stores objects comprising an image or text, names of the objects, or positions, colors, dimensions, resolutions, or aspect ratios of the one or more objects, which define the image-based product.

12. The method of claim 1, wherein the image-based product comprises a photo page, a photo collage, a photo book having a plurality of pages, a personalized greeting card, a photo stationery, a image print, a photo calendar, a photo banner, a photo card, a photo T-shirt, a photo coffee mug, a photo mouse pad, a photo key-chain, a photo collector, or a photo coaster.

13. The method of claim 1, wherein the image-based product comprises a page, wherein the page controller is configured to control the logics and invocations of the first component, the second component, and the third component to enable the design of the page.

14. The method of claim 1, wherein the functions in the first component is activated by a user.

15. The method of claim 14, wherein the functions in the first component define a user initiated movement of an image from a first location to a second location on the user interface.

16. A method for assisting a user to design an image-based product, comprising:
storing, on a computer device, a component dependency map that defines that the functions in a second component and a third component are to be executed after the functions in a first component, each of which comprises functions that define actions and states at the user interface on the computer device;
executing a page controller in association with the user interface on the computer device, wherein the page controller is configured to control the first component, the second component, and the third component in accordance to the component dependency map;
detecting an activation of the functions in the first component at the user interface by the first component;
executing functions of the second component and the third component in the user interface in accordance to the component dependency map;
sending a bundled request, by the page controller, to a product creation controller on the server to request data related to at least two of the first component, the second component, and the third component;
retrieving the data from a product model accessible to the product creation controller, wherein the product model stores specifications of the image-based product, wherein the specifications comprise an image or text, names of the objects, or positions, colors, dimensions, resolutions, or aspect ratios of the one or more objects, which define the image-based product; and
receiving the data from product creation controller by the page controller, wherein the functions of the first component, the second component, and the third component are executed using the data received from the server to result in a design of the image-based product to be produced by the image-service provider.

17. The method of claim 16, wherein the activation is detected by the first component and is communicated to the page controller, wherein functions of the second component and the third component are respectively executed by the second component and the third component in communication with the page controller.

18. The method of claim 16, wherein the functions in the first component is activated by a user.

19. A method for assisting a user to design an image-based product, comprising:
storing a first component and a second component on a computer device, the first component and the second component comprising functions that define actions and states at a user interface on the computer device;
storing, on a computer device, a component dependency map that defines that the functions in the second component are to be executed after the functions in a first component;
executing a page controller in association with the user interface on the computer device, wherein the page controller is configured to control the first component and the second component in accordance to the component dependency map;
detecting an activation of the functions in the first component at the user interface; and
invoking functions of the second component in the user interface in accordance with the component dependency map to obtain a design of the image-based product to be produced by the image-service provider.

20. The method of claim 19, further comprising:
storing a third component on the computer device; and
invoking functions of the third component in the user interface in accordance with the component dependency map, wherein component dependency map that defines that the functions in the third component are to be executed after the functions in a first component and the second component.
